(19) United States
(12) Patent Application Publication
(10) Pub. No.: US 2015/0000540 A1
(43) Pub. Date: Jan. 1, 2015

(54) COMPACTING APPARATUS

(71) Applicant: TOMRA SYSTEMS ASA, Asker (NO)

(72) Inventors: Terje Dehli, Oslo (NO); Lars Alfred Bech, Slemmestad (NO); Thomas Östby, Drammen (NO)

(21) Appl. No.: 14/377,130

(22) PCT Filed: Feb. 7, 2013
(86) PCT No.: PCT/EP2013/052486

§ 371 Date: Aug. 6, 2014

(30) Foreign Application Priority Data
Feb. 7, 2012 (NO) 20120125

(51) Int. Cl. B30B 9/32; B30B 1/26; B30B 15/28

(52) U.S. Cl. CPC B30B 9/321; B30B 15/285; B30B 1/261
USPC 100/35; 100/214; 100/209; 100/45; 100/48

(57) ABSTRACT

A compacting apparatus including: a compression plate, a piston having a surface facing the compression plate, and a drive mechanism configured to alternately move the piston towards and away from the compression plate such that an object may be compacted between the compression plate and said surface of the piston, wherein the drive mechanism can be positioned inside or partly outside the piston. Also, a reverse vending machine comprising such a compacting apparatus, use of such a compacting apparatus, and a method of compacting objects.

### TECHNICAL FIELD

The disclosure relates to a compacting apparatus, a reverse vending machine comprising such a compacting apparatus, use of such a compacting apparatus, and a method of compacting objects.

### BACKGROUND

WO 03051620 A1 discloses a machine for the compacting of bulky, solid materials (for example glass bottles, plastic and/or metal bottles and containers), in which the compacting action is carried out by a ram, provided with two crushing heads, capable of running in alternative rectilinear motion from a resting position to two crushing positions. The machine's crushing chamber, within which the workings of the machine are housed, accommodates one motor, the ram capable of alternative rectilinear motion activated by the motor, and two contrasting surfaces against which the solid waste products are compressed. The motor is made up of an electric motor reducer, connected to the ram by a gear drive. The output shaft of the electric motor reducer has two sprocket wheels, each coupled with a rack anchored to and so integral with the compactors which are thus made to move. The inversion of the rotation motion of the shaft of the motor reducer thus determines the inversion of the sliding direction of the compactors.

### SUMMARY

It is an object of the disclosure to provide an improved compacting apparatus.

### BRIEF DESCRIPTION OF THE DRAWINGS

The disclosure will now be described in more detail, with reference to the appended drawings showing an embodiment of the disclosure.

FIGS. 1-2 show a compacting apparatus with one compacting chamber and a grid release arm in accordance with an embodiment of the disclosure;

FIGS. 3-4 show a compacting apparatus with two compacting chambers without a grid release arm;

FIG. 5 is a perspective view of a piston of the present compacting apparatus;

FIG. 6 is a side view of an embodiment of the disclosure with two compacting chambers;

FIG. 7 is a perspective view of a plastic bottle insert;

FIG. 8 is a perspective view of a glass crusher insert;

FIG. 9 is a perspective view of a can flattener insert;

FIGS. 10-14 illustrate various details of a grid release mechanism in an embodiment of the disclosure;

FIG. 15 shows a blocked grid overload protection;

FIG. 16 is a perspective view of a plastic bottle insert;

FIG. 17 is a side view of the plastic bottle insert in FIG. 16;

FIG. 18 is an illustration of a grid type object holding device; and

FIG. 19 is an illustration of a plate type object holding device.

### DETAILED DESCRIPTION

The terminology used in the following description includes words and expressions used for convenience and is not limiting. The words “right”, “left”, “back”, “front”, “upper”, “lower”, “clockwise” and “counterclockwise” designate directions in the drawing to which reference is made, or to relative positions of features with respect to each other in the embodiments described. The relative arrangement of features in other embodiments than those illustrated in the drawings are within the scope of the disclosure as claimed. Unless specifically described as such, the terms “a”, “an” and “the” are not intended to be limited to one element, but should be understood to also include “one or more”.

The disclosure relates to an apparatus for compacting, compressing or crushing objects. Whether an object actually is compacted, compressed, crushed, or otherwise deformed may depend on the material from which it is made. These terms may be used interchangeably in the following description, and should not be interpreted to exclude each other, except if expressly stated.

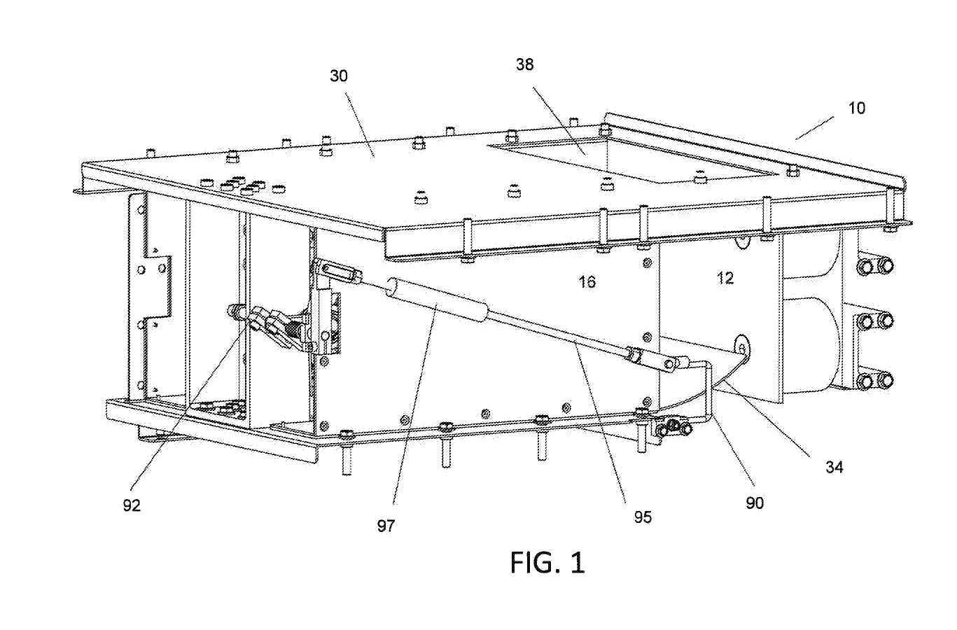

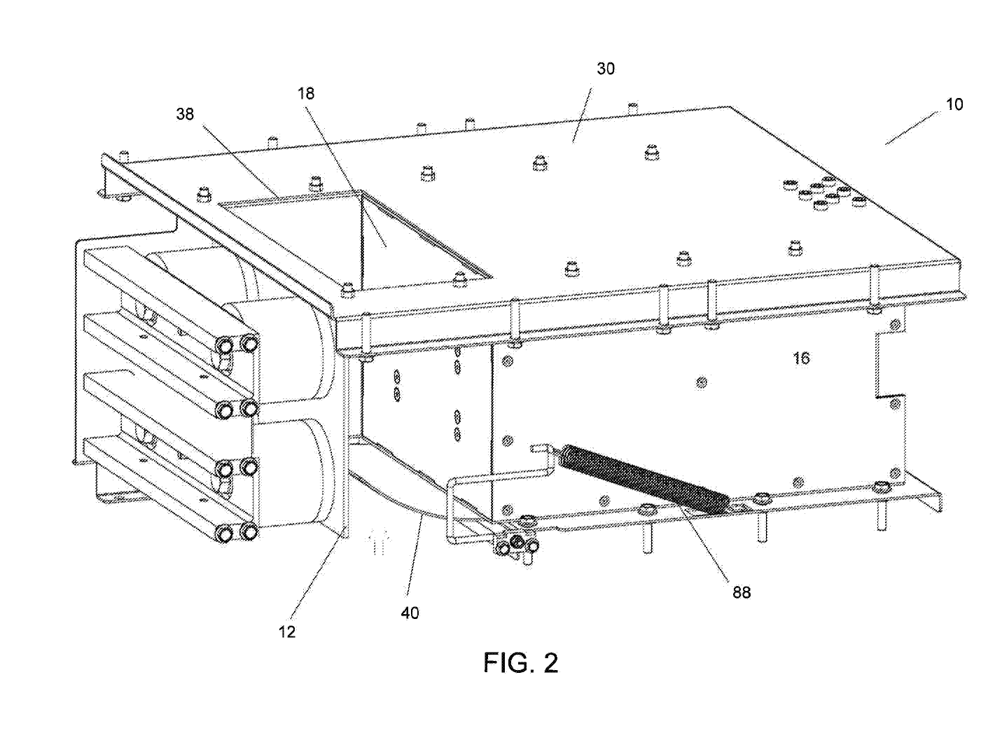

FIGS. 1-2 show a compacting apparatus 10 according to an embodiment of the disclosure, where compacting apparatus has one chamber.

According to this embodiment the compacting apparatus 10 comprises a compression plate 12 and a piston 16 having a surface 18 facing the compression plate 12. A drive mechanism adapted to alternately move the piston 16 towards and away from the compression plate 12 such that an object may be compacted between the compression plate 12 and said surface of the piston.

In an embodiment the drive mechanism may be positioned inside the piston 16. The drive mechanism is adapted to move the piston horizontally towards the compression plate 12 such that an object may be compacted or flattened between the compression plate 12 and the surface 18 of the piston.

The compacting apparatus 10 further comprises an object holding grid 34 pivotably attached to the frame 30 so that it may pivot about an axis 86. The object holding grid 34 is generally adapted to hold a non-compacted object in a compression chamber 38 between the compression plate 12 and the surface 18 of the piston 16. In an upper position of the object holding grid 34, the gap between the grid 34 and the compression plate 12 is sufficiently wide for a compacted object to fall through it, but sufficiently narrow so that the incoming non-compacted objects do not fall through the compression chamber 38 but are instead caught by the object holding grid 34. The grid 34 may then be pushed by the piston to a lower position as the piston moves towards the compression plate 12.

In FIG. 2 the piston 16 is shown in the retracted position, with a compression chamber 38 open. When the piston 16 moves forward (left) towards the compression plate 12, a grid 34 will be pushed down. When the piston 16 retracts, an elastic element 88 will pull the grid 34 up to its upper position.

The compacting apparatus 10 may include a reverse engage arm 92 for freeing uncompressed object from the holding grid. This may be useful for example if a non-compactable object is introduced into the compression chamber 38.

An elastic element 88 such as a spring or a rubber band is attached between the frame 30 and a lever arm 90 of the first object holding grid 34 for pivoting and biasing the grid 34 towards the upper position. The first grid 34 may then be pushed by the piston 16 to a lower position as the piston 16 moves towards the first compression plate 12. The lever arm 90 may also be used to manually pivot the first object holding grid 34 to the lower position (or in the opposite direction compared to the elastic element 88) in order to (temporarily) remove the first object holding grid 34 from the chamber 38. This may be useful for example if a non-compactable object is introduced into the compression chamber 38.

In an embodiment the drive mechanism can be positioned inside the piston 16. By placing the drive mechanism inside the piston 16, the drive mechanism is well protected against dirt and debris and the like that may occur in the apparatus 10. Also, placing the drive mechanism inside the piston 16 allows the apparatus 10 to be compact or small in size, whereby space may be saved.

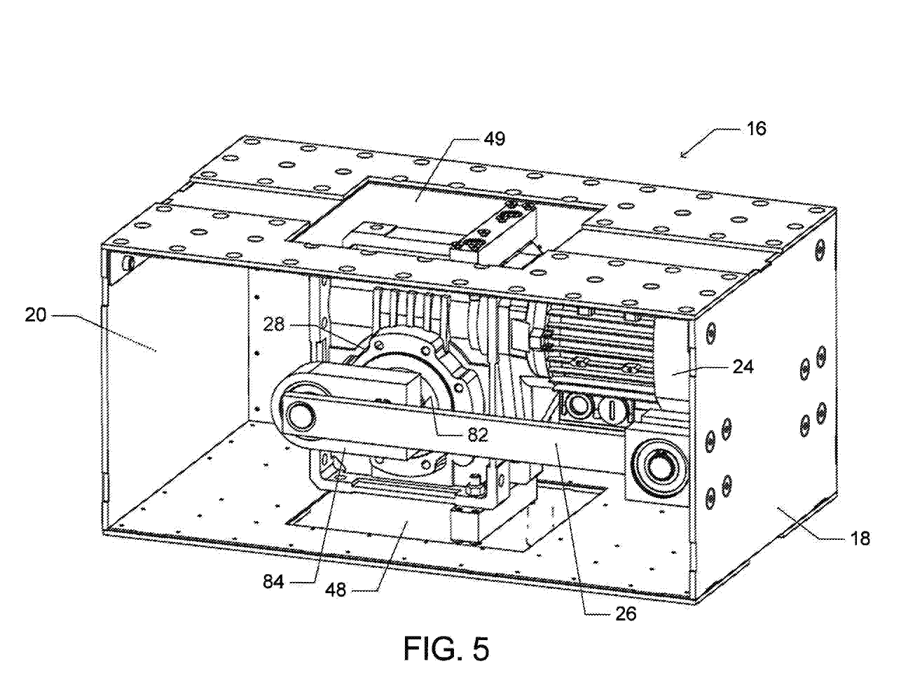

The drive mechanism includes a motor 24 and means adapted to translate rotation originating from the motor 24 into reciprocating linear motion of the piston 16, shown in FIG. 5. The means includes a rotating shaft 82 engaged by the motor 24, at least one crank 84 connected to the rotating shaft 82, and at least a rod 26. Where the rod is connected between the crank 84 and the inside of the piston 16 as illustrated in FIG. 5. The drive mechanism further includes a gearbox 28 connected between the motor 24 and the rotating shaft 82.

The compacting apparatus 10 further comprises frame 30 adapted to guide the piston 16 in a linear path to the compression plates 12. The frame may have a bottom glide plate adapted to support the piston 16, for low friction movement and minimum wear. Also, the outside of the piston may be covered by a plastic material for reducing friction and wear. The gearbox of the drive mechanism can be attached to the plate via an opening 48 in the bottom of the piston, as shown in FIG. 5. The opening 48 is enlarged in the sense that it is large enough not to interfere with the movement of the piston. As illustrated in FIG. 5 the piston may also have a corresponding upper opening 49 via which the gearbox 28 can be attached to the frame 30.

While in the embodiment described above the drive mechanism is positioned inside the piston it is consistent with the principles of the disclosure to position the drive mechanism partly outside the piston. In such embodiments, the drive mechanism may include motor positioned outside the piston, while the drive mechanism may include means adapted to translate rotation originating from the motor into reciprocating linear motion of the piston. The means may include a rotating shaft powered by the motor, at least one crank connected to the rotating shaft, and at least a rod. Where the rod is connected between a respective crank and the piston. The drive mechanism can further include a gearbox. The drive mechanism is generally adapted to move the piston horizontally towards the compression plate 12 such that an object may be compacted or flattened between the compression plate 12 and the surface of the piston. By placing the drive mechanism outside the piston, the drive mechanism is no longer confined to the limited space inside the piston.

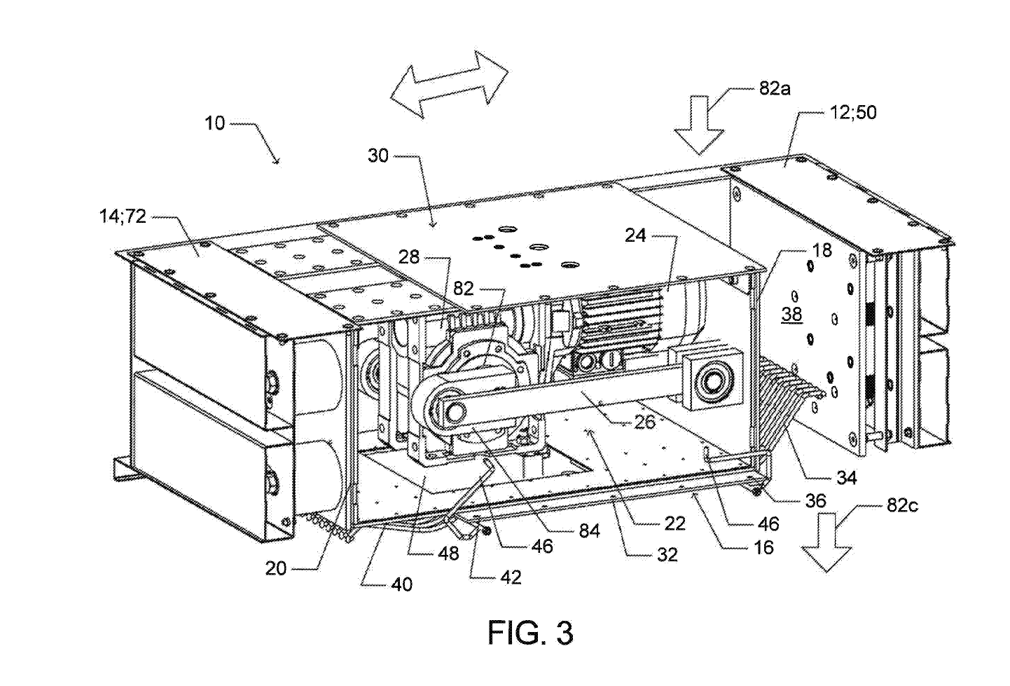

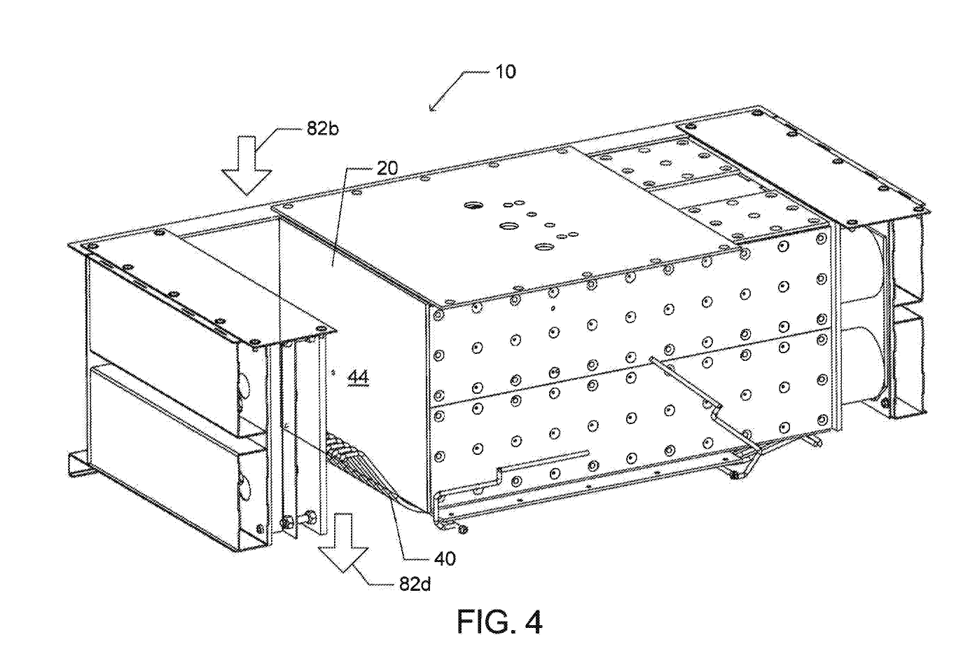

FIGS. 3-4 show a compacting apparatus 10 according to embodiments of the disclosure with two compacting chambers.

The compacting apparatus 10 comprises a first compression plate 12, and a second compression plate 14 arranged generally opposite the first compression plate 12.

The compacting apparatus 10 further comprises a piston 16. The piston 16 is arranged between the first and second compression plates 12, 14. The piston 16 has a first surface 18 facing the first compression plate 12, and a second surface 20 facing the second compression plate 14.

The compacting apparatus 10 further comprises a drive mechanism 22, as also seen in FIG. 5. The drive mechanism 22 is generally adapted to alternately move the piston horizontally a) towards the first compression plate 12 such that an object may be compacted or flattened between the first compression plate 12 and the first surface 18 of the piston and b) towards the second compression plate 14 such that another object may be compacted or flattened between second compression plate 14 and the second surface 20 of the piston.

The drive mechanism 22 is positioned inside the piston 16. By placing the drive mechanism 22 inside the piston 16, the drive mechanism 22 is well protected against dirt and debris and the like that may occur in the apparatus 10. Also, placing the drive mechanism 22 inside the piston 16 allows the apparatus 10 to be compact or small in size, whereby space may be saved.

In one embodiment, the drive mechanism 22 includes a motor 24 and means adapted to translate rotation originating from the motor 24 into reciprocating linear motion of the piston 16. The means may include a rotating shaft 82 powered by the motor 24, two cranks 84 connected to the rotating shaft 82 on each side, and two rods 26. Each rod 26 may be connected between a respective crank 84 and the inside of the piston 16 as illustrated in FIGS. 3 and 5. The drive mechanism according to this embodiment may further include a gearbox 28 connected between the motor 24 and the rotating shaft 82. In operation, as the shaft 82 is rotated by the motor 24, it will be appreciated that the piston will reciprocate as indicated by the double arrow in FIG. 3. It will also be appreciated that it is not necessary to change the drive direction of the motor 24 to achieve the reciprocating motion of the piston 16.

The compacting apparatus 10 further comprises a frame 30 adapted to guide the piston 16 in a linear path between the first and second compression plates 12, 14. The frame has a bottom glide plate 32 adapted to support the piston 16, for low friction movement and minimum wear. Also, the outside of the piston 16 may be covered by a plastic material for reducing friction and wear. The gearbox 28 of the drive mechanism 22 is attached to the plate 32 via an opening 48 in the bottom of the piston. The opening 48 is enlarged in the sense that it is large enough not to interfere with the movement of the piston 16. The piston 16 may also have a corresponding upper opening 49 via which the gearbox 28 can be attached to the frame 30, as illustrated in FIG. 5.

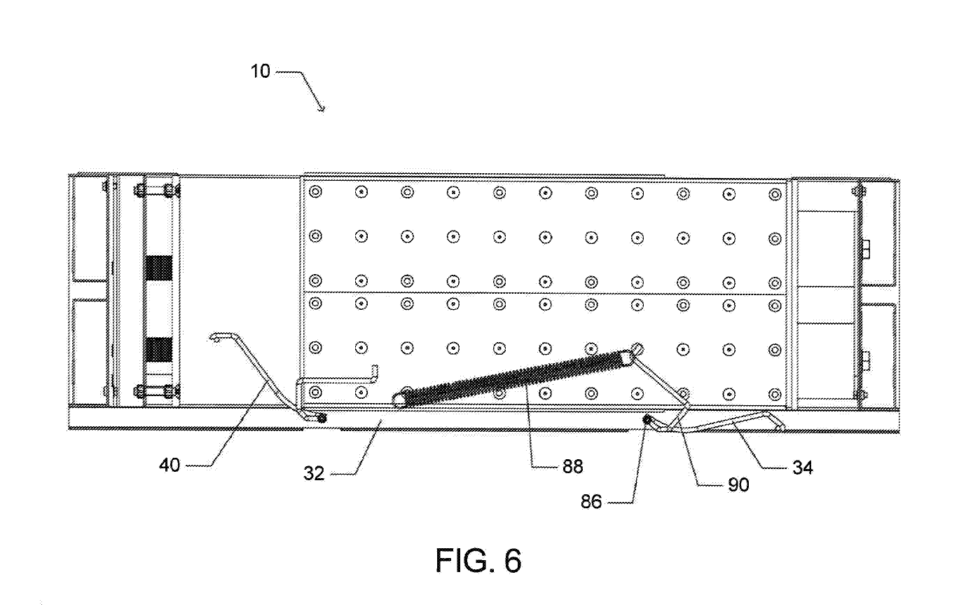

The compacting apparatus 10 further comprises a first object holding grid 34 arranged at one 36 end of the bottom glide plate 32 towards the first compression plate 12. Specifically, the first object holding grid 34 is pivotably attached to the frame 30 so that it may pivot about an axis 86. The first object holding grid 34 is generally adapted to hold a non-compacted object in a first compression chamber 38 between the first compression plate 12 and the first surface 18 of the piston 16, see FIG. 3. In this upper position of the first object holding grid 34, the gap between the grid 34 and the compression plate 12 is sufficiently wide for a compacted object to fall through it, but narrow enough so that the incoming non-compacted object does not fall through it and instead is caught by the object holding grid 34. An elastic element 88 such as a spring or a rubber band is attached between the frame 30 and a lever arm 90 of the first object holding grid 34 (see FIG. 6) for pivoting and biasing the grid 34 towards the upper position. The first grid 34 may then be pushed by the piston 16 to a lower position (see FIGS. 4 and 6) as the piston 16 moves towards the first compression plate 12. The lever arm 90 may also be used to manually pivot the first object holding grid 34 to the lower position (or in the opposite direction compared to the elastic element 88) in order to (temporarily) remove the first object holding grid 34 from the chamber 38. This may be useful for example if a non-compactable object is introduced into the compression chamber 38.

The compacting apparatus 10 further comprises a second object holding grid 40 arranged in the same way as the first object holding grid 34, but at the opposite end 42 of the bottom glide plate 32 towards the second compression plate 14.

A method of compacting objects using the compacting apparatus 10 comprises activating the drive mechanism 22 for alternately a) compacting an object between the first compression plate 12 and the first surface 18 of the piston 16 and b) compacting another object between the second compression plate 14 and the second surface 20 of the piston 16.

Specifically, the piston 16 may first be moved to the left in FIG. 3 towards the second compression plate 14, thereby exposing or opening the first compression chamber 38. A first object (not shown) falls into the first compression chamber 38 from above, as indicated by arrow 82a. The first object is held in the first compression chamber 38 by means of the first object holding grid 34. The piston 16 is then moved to the right towards the first compression plate 12, whereby the first object is compacted or flattened between the first compression plate 12 and the first surface 18 of the piston 16. As the piston 16 is moved towards the first compression plate 12 and hence away from the second compression plate 14, the second compression chamber 44 is exposed so that a second object may fall into the second compression chamber 44 from above, as indicated by arrow 82b in FIG. 4. Then, the piston 16 is again moved towards the second compression plate 14, whereby the second object may the compacted or flattened between the second compression plate 14 and the second surface 20 of the piston 16. As the piston 16 starts moving towards the second compression plate 14, the first compression plate 12 and the first piston surface 18 loosen the grip of the flattened first object which then falls out from the first compression chamber 38 in a gap between the first compression plate 12 and the first object holding grid 34 as indicated by arrow 82c.

Once the first compression chamber 38 again has been exposed, a third object (not shown) may fall into the first compression chamber 38. The flattened second object will fall out of the second compression chamber 44 when the piston 16 again starts moving towards the first compression plate 12 as indicated by arrow 82d. The above procedure may then be repeated for compacting further objects.

At least one of the first compression plate 12, the second compression plate 14, the first surface 18 of the piston 16, and the second surface 20 of the piston may include or be adapted to receive an exchangeable insert. This makes the compacting apparatus 10 very flexible when it comes to handing different kinds of objects depending on the current demand. Examples of exchangeable inserts will be described in the following.

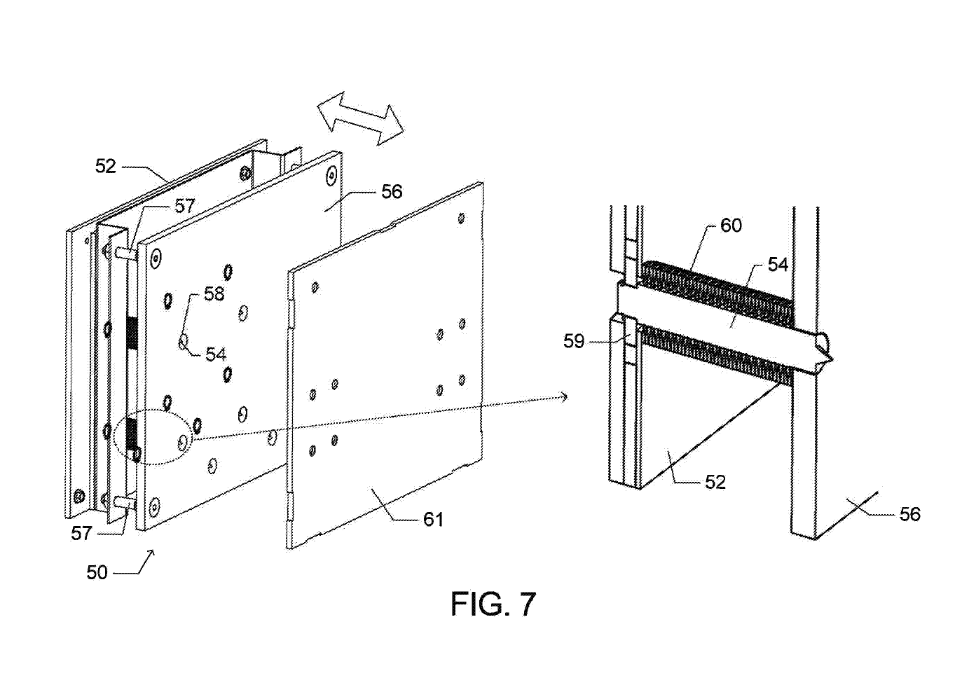

FIG. 7 shows a plastic bottle insert 50, which by way of example constitutes the first compression plate 12 in FIG. 2. The plastic bottle insert 50 is specifically adapted to compact and puncture objects such as plastic bottles. The plastic bottle insert 50 has a back plate 52 with a plurality of spikes 54 here pointing towards the first surface 18 of the piston 16 opposite the plastic bottle insert 50. The plastic bottle insert 50 also has a front plate 56 with openings 58 corresponding to the spikes 54. The front plate 56 is biased by a spring mechanism 60 towards a first position in which the spikes 54 do not project through the openings 58, but the front plate 56 can be pushed back by an object to be compacted (which in turn is pushed by the piston 16) against the spring mechanism 60 to a second position in which the spikes 54 do project through the openings 58 and thereby penetrates the object. The spring mechanism 60 may for instance include disc springs. Retaining bolts 57 guides the front plate 56 and prevents the spring mechanism 60 to push the front plate 56 off the spikes 54. Also, each spike 54 may be mounted using a support ring 59 made in flexible material to allow a limited sideways movement of the spikes 54, which prevents the spikes 54 from jamming during operation. Also, a plastic plate 61 may be fastened to the first surface 18 of the piston 16. In use, the spikes 54 penetrate into this plastic plate 61 when the piston 16 is fully extended. This ensures that the object (i.e. the plastic bottle) is fully punctured. Then, as the piston 16 is retracted, the spring mechanism 60 forces the front plate 56 towards the first position, whereby the compacted object is pushed off the spikes 54 by the front plate 56.

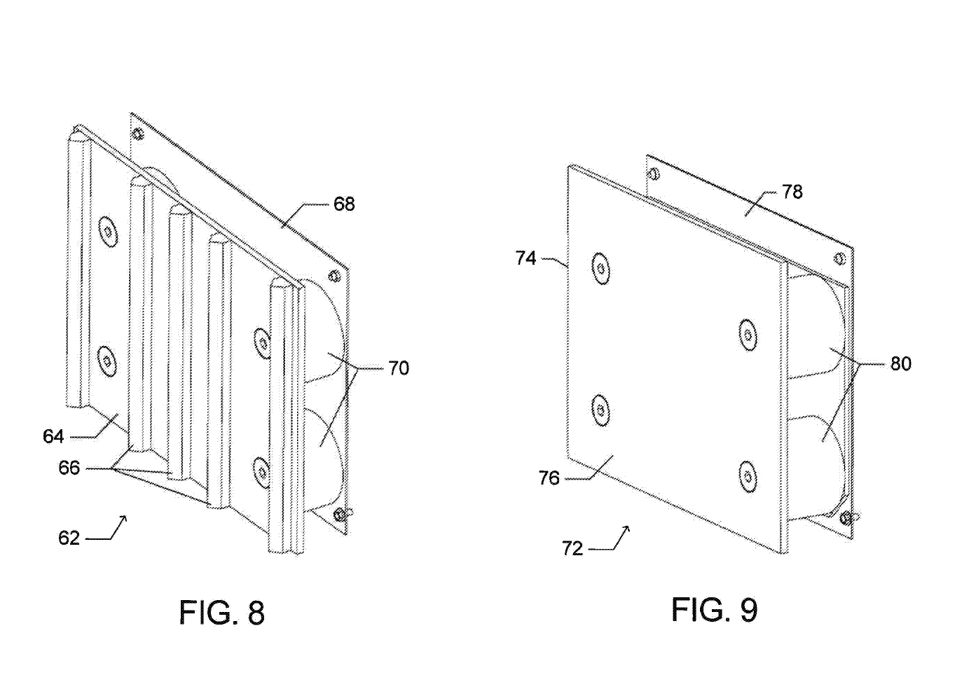

FIG. 8 shows a glass crusher insert 62. The glass crusher insert 62 is specifically adapted to crush objects such as glass bottles. The glass crusher insert 62 has a front plate 64 with a plurality of elongated and vertical rails 66 facing the second surface 20 of the piston 16 opposite the glass crusher insert 62. The glass crusher insert 62 optionally has a back plate 68 with dampers and/or springs 70 between the front plate 64 and the back plate 68 to allow a specific limited movement of the front plate 64 relative to the back plate 68.

FIG. 9 shows a can flattener insert 72, which by way of example constitutes the second compression plate 14 in FIG. 3. The can flattener insert 72 is specifically adapted to flatten aluminum and steel cans. The can flattener insert 72 has a front plate 74 with a substantially smooth or even surface 76 facing the second surface 20 of the piston 16 opposite the can flattener insert 72. The can flattener insert 72 optionally has a back plate 78 with dampers and/or springs 80 between the front plate 74 and the back plate 78 to allow a specific limited movement of the front plate 74 relative to the back plate 78. The surface 76 of the front plate 74 may be provided with a pattern (not shown) adapted to impose a marking on the compacted object, so that it can be identified what (type of) compacting apparatus that compacted the object.

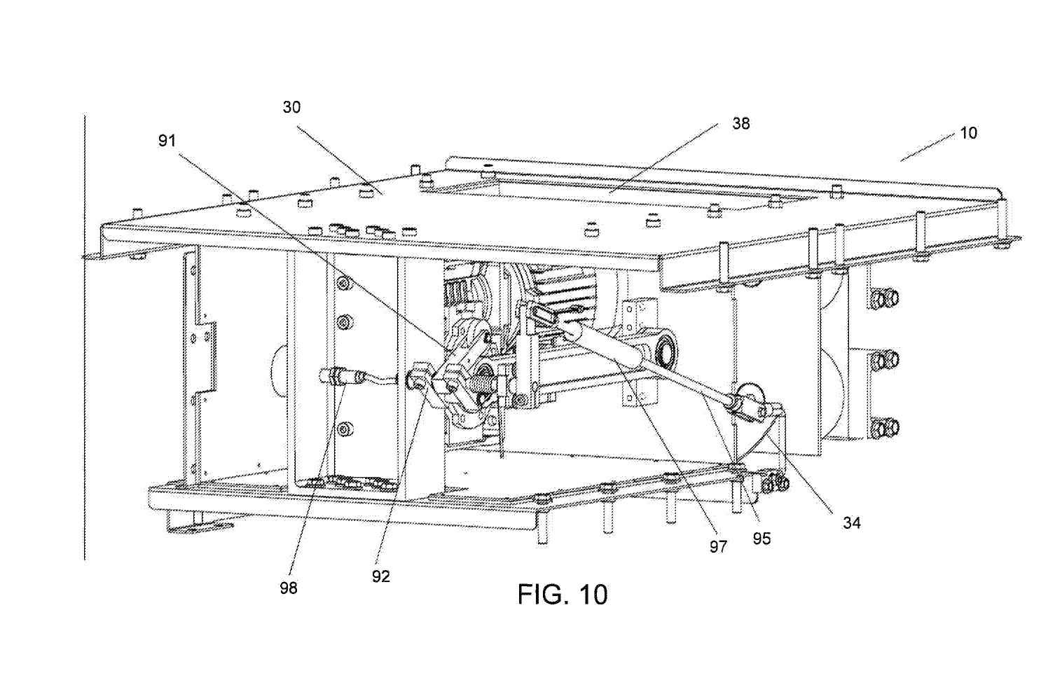

FIG. 10 shows how the reverse engage arm is attached to the actuator arm 91 and a release arm 95. The release arm 95 is attached to the object holding grid 34 in order to allow the object holding grid 34 to be opened in order to release objects that cannot be compressed or fully compressed, as will be described in further detail below.

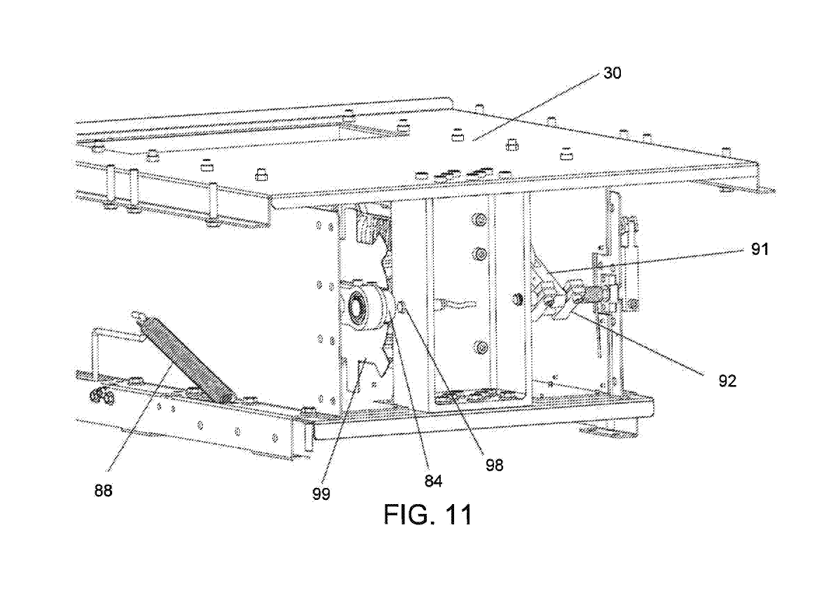

FIG. 11 shows how the signal wheel 99 can be attached to the crank 84. In other embodiments the signal wheel can be attached directly to the rotating shaft 82, or otherwise be directly or indirectly driven by the rotation of the rotating shaft 82. A rotation sensor 98 senses the rotation of this signal wheel 99. It should be noted that the sensor does not have to be a rotation sensor, and that in other embodiments it may be the linear motion of the piston 16 or the movement of other moving parts in the is apparatus that is detected by the sensor as long as the detected motion, or lack thereof, is a reliable indication of whether the piston is moving.

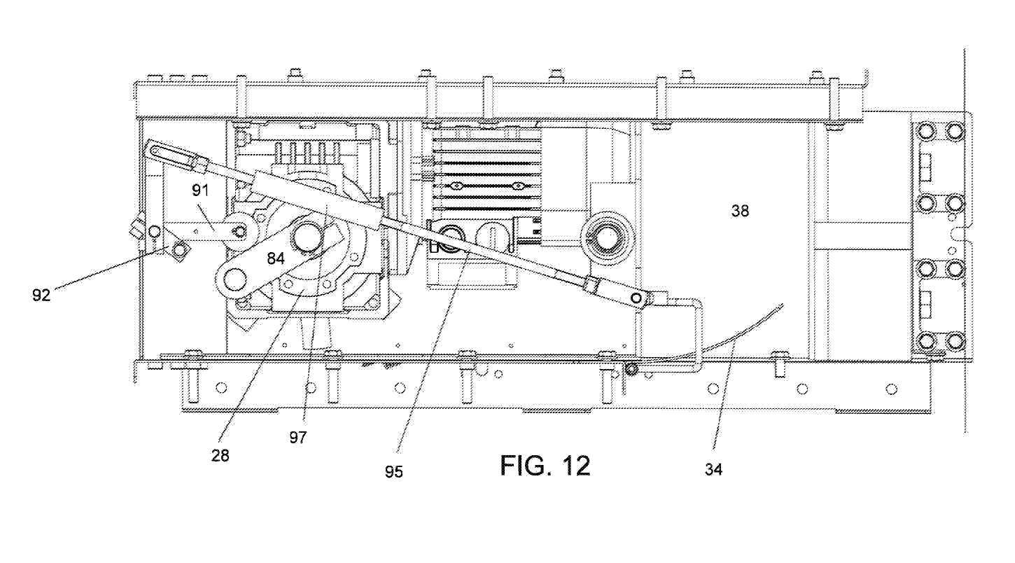

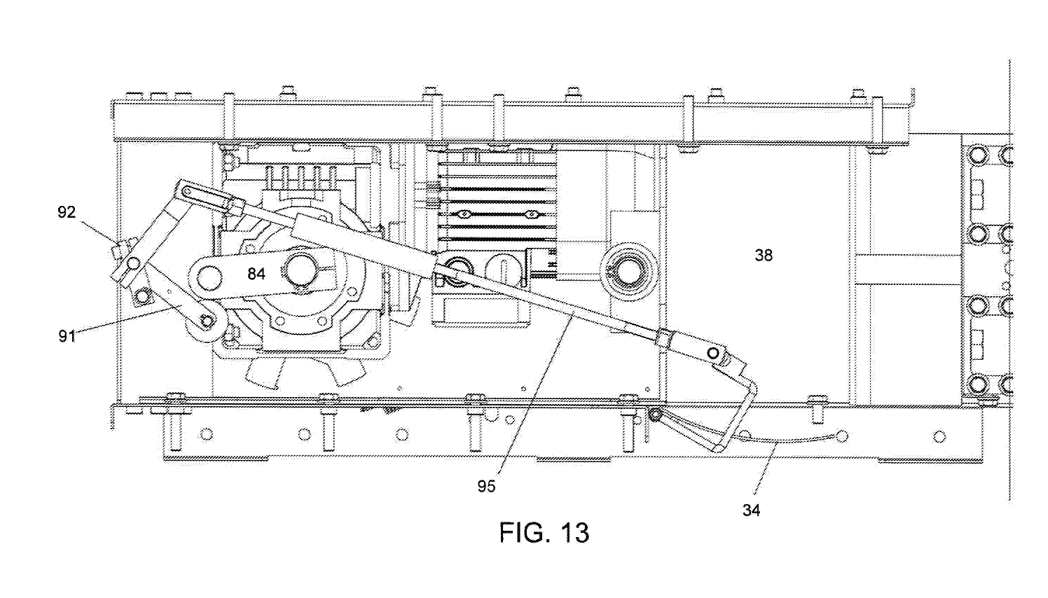

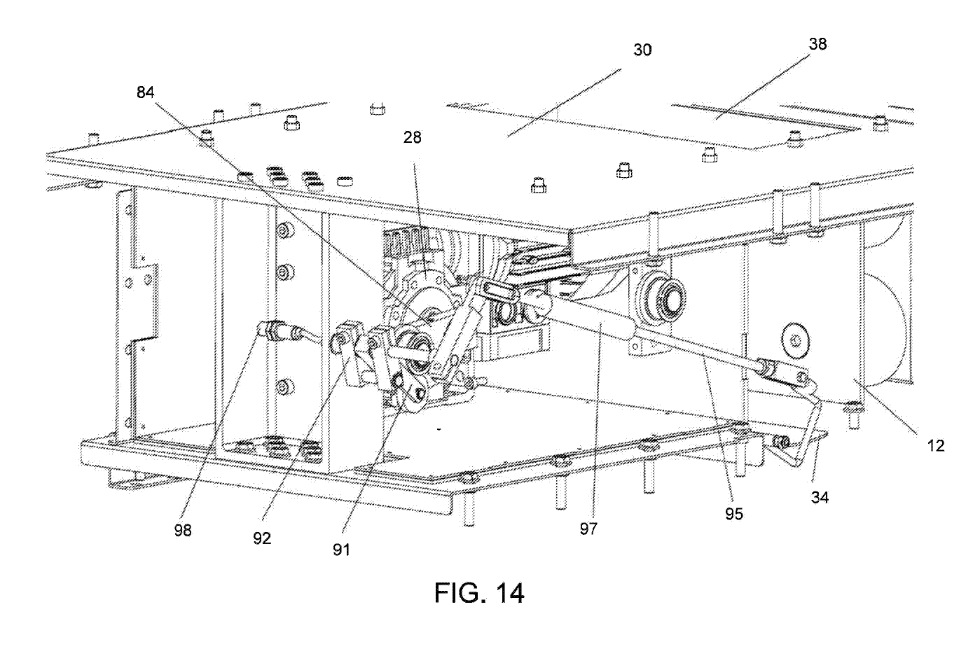

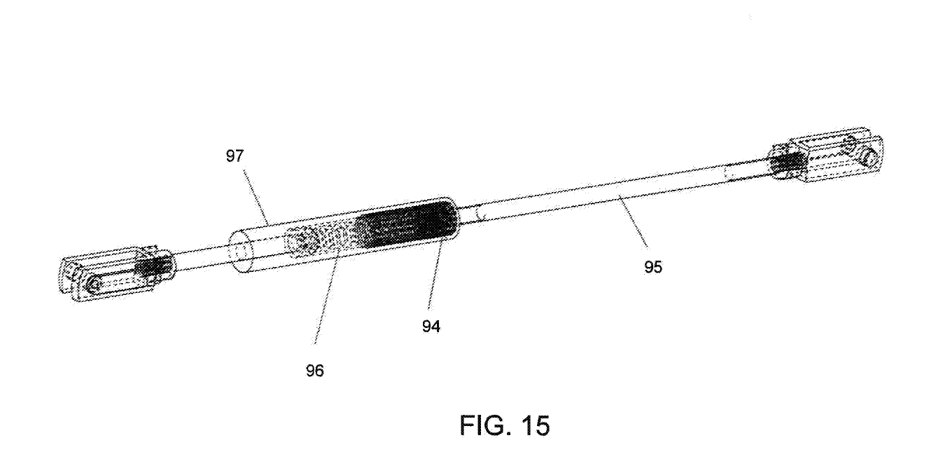

Referring now to FIG. 12, during normal operation the driving mechanism 22 causes the piston to move as described above. In the embodiment illustrated in FIG. 12 this means that the crank 84 rotates clockwise as seen on the drawing and the actuator arm 91 is lifted when the piston 16 is substantially in the retracted position. The actuator arm 91 does not move the reverse engagement arm 92. Also, no motion is transferred to the release arm 95, which follows the normal movement of the object holding grid 34.

On the other hand, if an object that cannot be fully compressed is positioned between the piston 16 and the compression plate 12, the piston 16 stalls and the rotation sensor 98 detects the lack of motion. This causes a control system to reverse the drive mechanism 22. When this happens the crank 84 will rotate counterclockwise and push the actuator arm 91 in a downward direction as shown in the drawing. The reverse engagement arm 92 will now be engaged and transfer motion to the release arm, which in turn will push the grid such that it pivots downward. The grid 34 is pushed considerably past its normal lower position (for instance 60° past horizontal position) opening up the bottom of the compacting chamber so the uncompressible object can fall out and out of the way

When the crank 84 rotates past the wheel arm 94, the grid spring 88 will pull the grid 34, the wheel arm 91, the grid release arm 92 and the grid release arm 94-97 back to normal position.

When the rotation sensor 98 detects at least one full rotation of the crank 84, the reverse motion of the motor can be stopped and normal forward motion is started

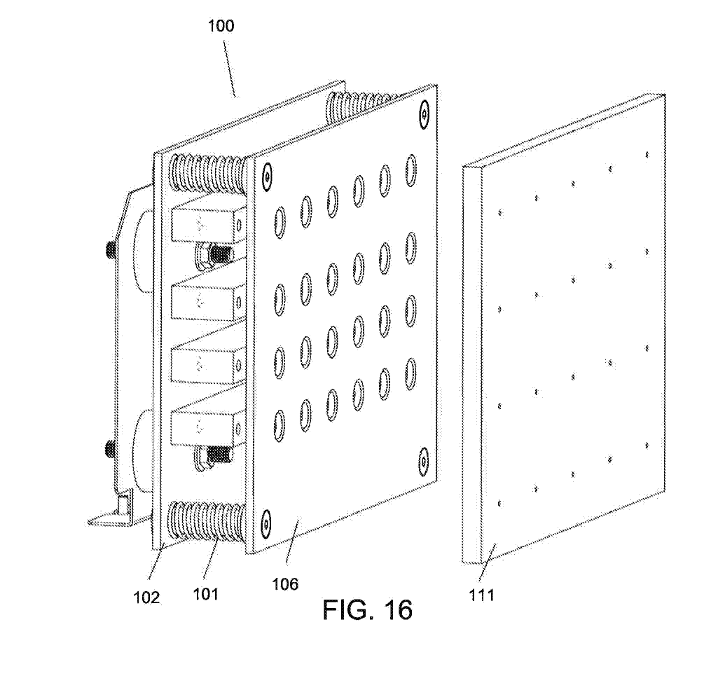

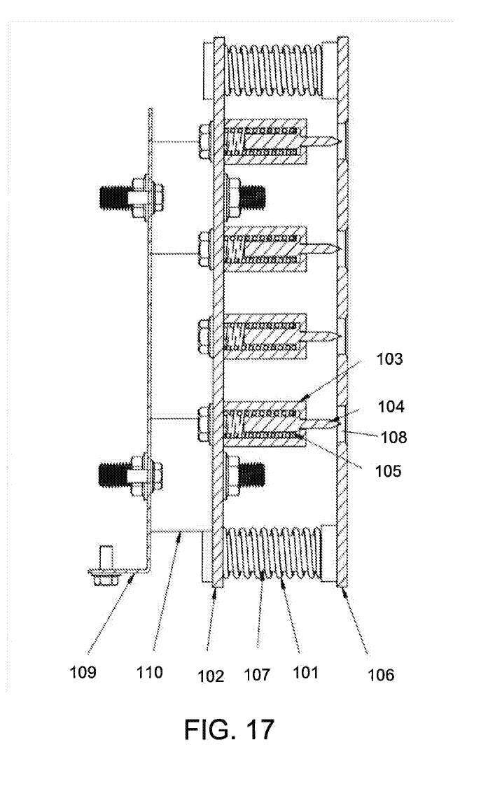

Reference is now made to FIG. 16 an 17, which show a compression plate insert configured to operate essentially in the same way as that which is described above with reference to FIG. 7, but with some additional features. In this embodiment of the compression plate 12 the spikes 104 are individually supported by springs 105, allowing them to be pushed in when meeting an incompressible object, something which may prevent damage to the spikes 104. The holes or openings 108 in the front plate 106 are is considerably larger than the diameter of the spikes 104, typically 3 to 4 times larger.

All the dampers 110 and springs 101, 104 allow the front plate 106 move relatively freely with regards to the pins 104, and the back plate 102 and can move relatively freely with regards to the holder plate 109. This free range of movement allows the compression plate to be pushed in in different way, (askew, on one corner only, etc.) without any jams of the pins or plates.

While the embodiments described above all show an object holding grid 34, this particular device may in some embodiments have other configurations. While a grid may allow objects that can be crushed to fall through the grid, and also allow objects that remain intact, while deformed, to fall through when the grid is opened or retracted, objects that are elastic, flexible or that becomes shredded, may get stuck to the grid. In some embodiments a plate may be chosen instead of a grid in order to avoid this. Generally speaking, then, the object holding grid may be an object holding device, which may be an object holding grid, an object holding plate, or something similar.

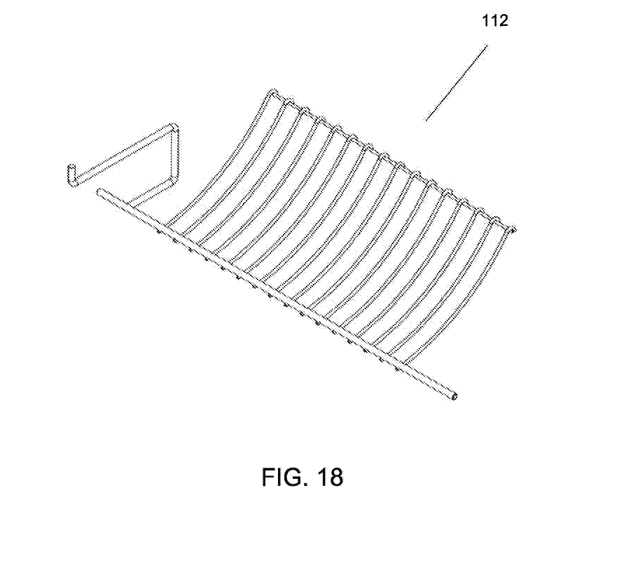

FIG. 18 shows an embodiment of an object holding device 113, where the object holding device comprises of a grid. The grid is adapted to hold a non-compacted object in the compression chamber and to allow other articles than the object to fall through the grid. Other articles may here be dirt or fluids attached to the object or inserted to the chamber with the object.

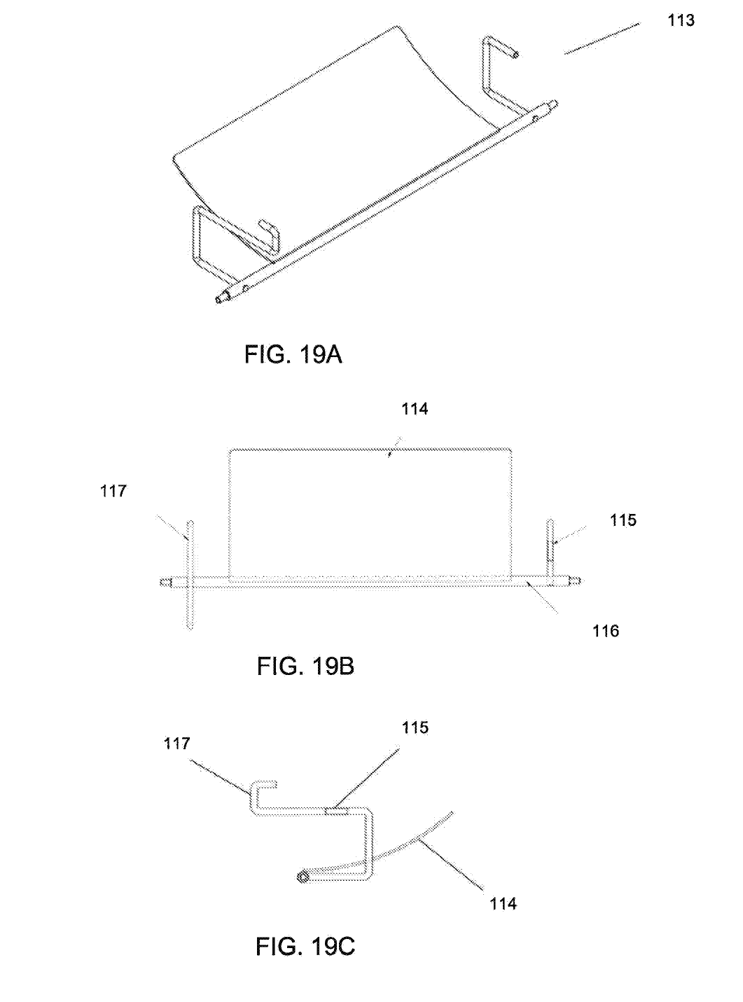

FIG. 19a-c shows an embodiment of an object holding device, where the holding device is pivotably attached to the frame (not shown) so that it may pivot about an axis 116. The holding device 113 comprises of a lever arm 117 and holding plate 114. The lever arm 117 may be used to pivot the holding plate 114 to the lower position. The holding plate 114 is adapted to hold a non-compacted object in the compression chamber, and after the objects are compacted in the chamber the holding plate 114 allows the object to slide easy past the holding plate 114, the holding plate 114 being in the lower position.

The present compacting apparatus 10 may for instance be used for compacting returnable objects, for example cans, bottles or other containers, in a reverse vending machine (RVM). The compacting apparatus 10 may be used both in a backroom solution, and in a stand-alone RVM (which includes container reception, compacting and storing). The compacting apparatus 10 may also be retrofitted to existing RVMs.

The person skilled in the art will realize that the disclosure by no means is limited to the embodiments described above. On the contrary, many modifications and variations are possible within the scope of the appended claims.

Also, the drive mechanism may include a linear actuator, wherein the compacting apparatus further comprises a controller adapted to alternately activate the linear actuator in opposite directions for imparting reciprocating linear motion to the piston. The linear actuator may for instance be a hydraulic actuator.

Also, the compacting apparatus may comprise a machine adapted to pivot the object holding grid in the opposite direction compared to the spring and thereby remove the object holding grid from the compression chamber. Here, the compacting apparatus may further comprise any sensors adapted to detect if the drive mechanism is unintentionally stopped and to supply a corresponding control signal to said machine instructing it to automatically remove the object holding grid from the compression chamber.

1. A compacting apparatus, comprising:
a compression plate;
a piston having a surface facing the compression plate; and
a drive mechanism configured to alternately move the piston towards and away from the compression plate such that an object may be compacted between the compression plate and said surface of the piston,
wherein at least one of the compression plate and the surface of the piston includes or is configured to receive an exchangeable insert.

2. A compacting apparatus according to claim 1, wherein
said compression plate is a first compression plate,
the apparatus further comprises a second compression plate arranged generally opposite the first compression plate,
the piston is arranged between the first and second compression plates and has a second surface facing the second compression plate, and
the drive mechanism is configured to move the piston towards the second compacting plate such that another object may be compacted between second compression plate and the second surface of the piston as the piston is moved away from the first compression plate.

3. A compacting apparatus according to claim 1, wherein the drive mechanism includes a motor and means configured to translate rotation originating from the motor into reciprocating linear motion of the piston.

4. A compacting apparatus according to claim 3, wherein said means includes a rotating shaft powered by the motor, at least one crank connected to the rotating shaft, and at least one rod connected between the crank(s) and the inside of the piston.

5. A compacting apparatus according to claim 4, wherein the drive mechanism further includes a gearbox connected between the motor and the rotating shaft.

6. A compacting apparatus according to claim 1, wherein the drive mechanism includes a linear actuator, and wherein the compacting apparatus further comprises a controller configured to alternately activate the linear actuator in opposite directions for imparting reciprocating linear motion to the piston.

7. A compacting apparatus according to claim 1, wherein a stationary part of the drive mechanism is attached to a stationary part outside the piston via an opening in the piston, and wherein a reciprocating part of the drive mechanism is attached to the inside of the piston.

8. A compacting apparatus according to claim 1, further comprising a frame configured to guide the piston in a linear path towards and away from the compression plate.

9. A compacting apparatus according to claim 8, wherein the frame has a bottom glide plate configured to support the piston, and wherein an object holding grid is arranged at one end of the bottom glide plate towards the compression plate and configured to hold a non-compacted object in a compression chamber between the compression plate and the surface of the piston.

10. A compacting apparatus according to claim 9, wherein the object holding grid is pivotably attached to the frame, and wherein an elastic element is attached between the frame and the object holding grid and configured to pivot and bias the object holding grid towards a position in the compression chamber where it may hold the non-compacted object.

11. A compacting apparatus according to claim 10, wherein the object holding grid includes or is attached to a manually operable lever arm for pivoting the object holding grid in the opposite direction compared to said element and thereby remove the object holding grid from the compression chamber.

12. A compacting apparatus according to claim 10, further comprising a machine configured to pivot the object holding grid in the opposite direction compared to said element and thereby remove the object holding grid from the compression chamber.

13. A compacting device according claim 12, further comprising a sensor configured to detect if the drive mechanism is unintentionally stopped and to supply a corresponding control signal to said machine instructing it to automatically remove the object holding grid from the compression chamber.

14. A compacting apparatus according to claim 1, wherein the drive mechanism is positioned inside the piston.

15. A compacting apparatus according to claim 1, wherein the exchangeable insert is a compression plate insert which has a back plate with a plurality of spikes pointing towards the compression plate or a surface of the piston opposite the compression plate insert and a front plate with openings corresponding to the spikes, wherein the front plate is biased by a spring mechanism towards a first position in which the spikes do not project through the openings but may be pushed back against the spring mechanism to a second position in which the spikes do project through the openings.

16. A compacting apparatus according to claim 15, further comprising a buffer plate arranged on the compression plate or the surface of the piston opposite the compression plate insert.

17. A compacting apparatus according to claim 1, wherein the exchangeable insert is a compression plate insert which has a back plate with a plurality of spikes pointing towards the compression plate or a surface of the piston opposite the compression plate insert and a front plate with openings corresponding to the spikes, wherein the front plate is biased by a spring mechanism towards a first position in which the spikes do not project through the openings but may be pushed back against the spring mechanism to a second position in which the spikes do project through the openings, and wherein the spikes are individually attached to springs.

18. A compacting apparatus according to claim 1, wherein the exchangeable insert is a glass crusher insert which has a front plate with a plurality of elongated rails facing the compression plate or a surface of the piston opposite the glass crusher insert and optionally a back plate with dampers and/or springs between the front plate and the back plate to allow a specific limited movement of the front plate relative to the back plate.

19. A compacting apparatus according to claim 1, wherein the exchangeable insert is a can flattener insert which has a front plate with a substantially smooth or even surface facing the compression plate or a surface of the piston opposite the can flattener insert and optionally a back plate with dampers and/or springs between the front plate and the back plate to allow a specific limited movement of the front plate relative to the back plate.

20. A compacting apparatus according to claim 19, wherein said surface of the front plate is provided with a pattern configured to impose a marking on a compacted object.

21. A compacting apparatus, comprising:
a compression plate;
a piston having a surface facing the compression plate;
a drive mechanism configured to alternately move the piston towards and away from the compression plate such that an object may be compacted between the compression plate and said surface of the piston;
a sensor capable of detecting the movement of the piston; and
a control system configured to temporarily reverse the direction of the drive mechanism when said sensor detects an undesirable interruption of movement of the piston.

22. A compacting apparatus according to claim 21, wherein said drive mechanism includes a motor with a rotating shaft, which is connected to and drives a crank connected to a rod for translating rotational motion into linear motion.

23. A compacting apparatus according to claim 22, wherein said sensor is a rotation sensor detecting the rotation of a signal plate attached, directly or indirectly, to the rotating shaft.

24. A compacting apparatus according to claim 21, further comprising:
a pivotably attached object holding grid arranged to hold non-compacted objects in a compression chamber defined by the respective surfaces of the piston and the compression plate, and to allow compacted objects to fall out of the compression chamber.

25. A compacting apparatus according to claim 24, further comprising:
an arrangement of one or more arms or rods configured to be engaged by the crank when the drive mechanism is reversed and to pivot the object holding grid such that an opening is created, allowing non-compacted objects to fall out of the compression chamber.

26. A compacting apparatus according to claim 25, wherein said arrangement of one or more arms or rods is an assembly including a actuator arm attached to a reverse engage arm, which in turn is attached to a release arm, and where
said actuator arm is engaged by the crank when the piston is substantially in a retracted position and pushed in a first direction when the drive mechanism is running in a forward direction and in a second direction when the drive mechanism is running in a reversed direction;
said actuator arm is attached to the reverse engage arm such that the reverse engage arm does not transfer any motion to the release arm when the crank pushes the actuator arm in said first direction, and that the reverse engage arm transfers motion to the release arm such that the release arm acts to pivot the object holding grid when the crank pushes the actuator arm in said second direction.

27. A compacting apparatus according to claim 26, wherein said release arm includes an overload protection including a spring which allows the release arm to be temporarily deformed if said object holding device is prevented from being pivoted by the release arm.

28. A reverse vending machine comprising a compacting apparatus according to claim 1.

29. A method of compacting objects, the method comprising compacting returnable objects with a compacting apparatus according to claim 1, wherein the returnable objects are selected from cans, bottles or other containers, wherein the compacting apparatus is a reverse vending machine.

30. Method of compacting objects using a compacting apparatus according to claim 1, which method comprises:
activating the drive mechanism of the compacting apparatus for alternately moving the piston towards and away from the compression place such that an object is compacted or flattened between the compression plate and the surface of the piston.
